(19) United States
(12) Patent Application Publication
(10) Pub. No.: US 2017/0036595 A1
(43) Pub. Date: Feb. 9, 2017

(54) Bracket and Light Assembly with Remote Light Activation

(71) Applicant: Nicky Wright, Atlanta, GA (US)

(72) Inventor: Nicky Wright, Atlanta, GA (US)

(21) Appl. No.: 14/816,826

(22) Filed: Aug. 3, 2015

(51) Int. Cl. B60Q 1/26; B60Q 1/30; F21V 23/04; F21V 21/08; F21L 4/00

(52) U.S. Cl. CPC B60Q 1/2661; F21V 21/08; F21L 4/00; F21V 23/0435; B60Q 1/30

(57) ABSTRACT

An apparatus is described that forms a removable, remote-activated illumination system. The system is composed of a two section bracket, where the bracket may be installed on top of a door of cargo trailer, on the edge of the roof of a cargo trailer, or on any edge in an area where illumination is desired but not currently installed. The bracket locks into place when installed and contains a control circuit to receive wireless control signals to turn the light on and off.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

The present invention relates generally to lights that are associated with a trailer of a tractor-trailer long haul truck. Long haul trucks typically have a number of lighting systems installed both on and within the tractor portion and the trailer portion of the truck. Many of these lighting systems are installed to provide for visibility and safe operation as these trucks wend their way across the country on highways and secondary roads. Visibility is important because these trucks frequently travel at night, in poorly lit areas. Safety is another concern because the trailers are often loaded or unloaded after dark and in back lot or back door areas that have lighting systems that are underpowered or not capable of being controlled by the driver of the truck. Functionality and control are important to truck drivers mainly because they often need light upon command when they leave or arrive at either terminus of a trip.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a rear view of remote controlled lights installed on the back doors of a trailer consistent with certain embodiments of the present invention.

FIG. 2 is a side-rear view of remote controlled lights installed on the back doors of a trailer consistent with certain embodiments of the present invention.

FIG. 3 is a top view of a bracket closure component of the remote controlled lights consistent with certain embodiments of the present invention.

FIG. 4 is a cutaway view of the bracket closure and bracket of the remote controlled lights consistent with certain embodiments of the present invention.

FIG. 5 is a top view of the remote controlled lighting clamp installed on the back doors of a trailer consistent with certain embodiments of the present invention.

FIG. 6 is a view of the bracket and light assembly for the remote controlled lights consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Long haul semi tractor-trailer rigs often travel at night or into areas that have little or no ambient or artificial lighting source. This lack of illumination can make backing up to park a trailer more challenging for the driver. Additionally, the lack of light can make unloading and loading a trailer at night more difficult and dangerous than it would be without such a source of illumination. Safety and security for the driver are also considerations when a trailer is in a largely deserted area late at night, or when loading or unloading cargo early in the morning when few other people are in the vicinity. Other issues can occur on the road when mechanical problems cause a tractor-trailer to stop on roads that have no illumination and the mechanical issue requires opening the back trailer doors where the brighter sources of light, such as the headlamps, installed on the tractor-trailer rig do not reach. For these reasons, and more not enumerated in this document, it would be advantageous to have a bright source of illumination that may be operated upon the command of the driver.

The innovation disclosed herein provides a solution for the lack of illumination at the back doors of a trailer that is attached to the tractor of a long haul cargo truck, also known as a semi. In an embodiment, the disclosed solution is a bracket that fits over the top edge of the trailer doors of a cargo trailer, where upon each side of the bracket one or more high-lumen lights are installed. In this embodiment the high-lumen lights are oriented in a downward direction such that the illumination begins at the top of the trailer doors and illuminates everything from the lens of the light to the ground below. The bracket upon which the lights are mounted is separable such that the bracket may be pulled apart to permit the easy installation and removal of the lights so as to permit a driver to purchase one bracket and light assembly for each trailer door. The bracket and light assembly may then be removed from one set of trailer doors and installed on another set of trailer doors as required by the driver. The bracket also contains a shock absorber material to permit a tight fit for trailer doors of differing thicknesses and to absorb shocks to the bracket and light assembly that occur in the ordinary use of the bracket and light assembly, thus minimizing damage to the bracket and light assembly and extending the useful life of the unit.

The lights may also have a switch component that starts and stops the operation of the lights upon the command of the driver. Thus, the lights may be turned off during actual travel of the tractor-trailer, minimizing the distraction to other drivers, and turned on when the driver has need of illumination such as during backing up operations and loading, unloading, and checking cargo.

Although particular exemplary embodiments of the innovation will be presented herein, it should be apparent that additional embodiments may be accessible to those of ordinary skill in the art without departing from the spirit of innovation of the recited embodiments.

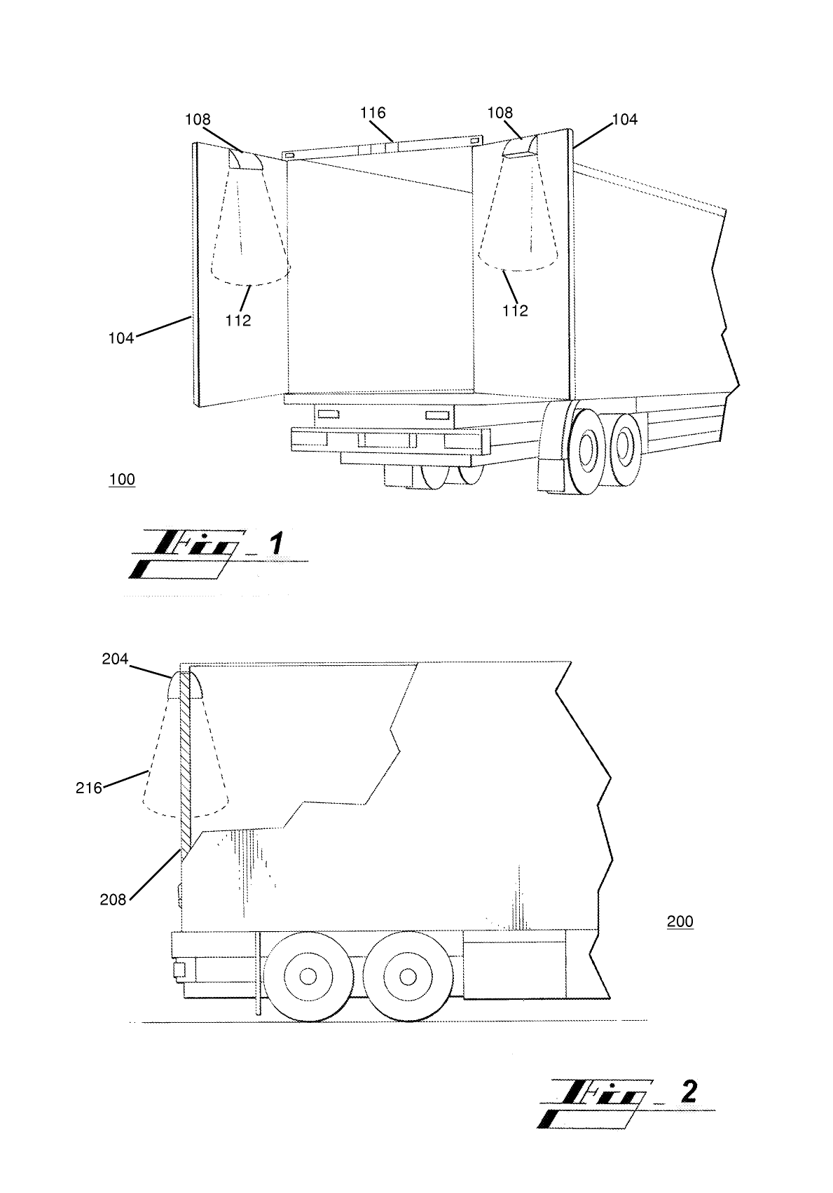

Turning now to FIG. 1, consistent with certain embodiments of the invention this figure presents a rear view of remote controlled lights installed on the back doors of a trailer consistent with certain embodiments of the present invention. In this exemplary embodiment, a view of the back end of a long haul cargo trailer 100 is presented, where the doors 104 open to permit access to the trailer cargo area. In a typical long haul cargo trailer 100 configuration, these doors 104 are located at the end of the trailer furthest from the tractor and the driver compartment (not shown). In this embodiment, the bracket and light assembly 108 is installed at the top edge of each back door 104 and oriented such that the illumination from the lights 112 in the bracket and light assembly 108 points straight down. In this orientation, the lights 112 provide illumination for the surface of the doors, the back portion of the cargo area, and the area behind the trailer 100 all the way to the ground. The lights 112 may be LED, Hallogen, Incandescent, or any other light source that is configured to be installed in the bracket and light assembly 108. The lights 112 may also be of any illumination value, where the illumination value is measured in the lumen scale that is standard in the lighting industry.

The bracket and light assembly 108 is shown in this exemplary embodiment as being installed at the top of the doors 104 so as to provide lighting to the back of the trailer and the ground area behind the trailer 100. However, in additional exemplary embodiments the bracket and light assembly 108 could be removed from the top of the doors 104 and reinstalled at the top edge of the trailer 116, oriented so as to illuminate the interior of the cargo area of the trailer, or on the sides of the doors 104 so as to provide cross illumination of the cargo and back end of the trailer without departing from the spirit of the invention. The ability to remove and reattach the bracket and light assembly without having to relocate wiring or depend upon pre-installed clips or other securing means is a novel feature of the instant invention.

Turning now to FIG. 2, consistent with certain embodiments of the invention is a side-rear view of remote controlled lights installed on the back doors of a trailer consistent with certain embodiments of the present invention. The end of the long haul cargo trailer 200 is shown in this exemplary embodiment with the bracket and light assembly 204 installed on a closed trailer door 208 such that the light from a lamp 212 mounted within the portion of the bracket and light assembly 204 that is associated with the exterior surface of the trailer door 208 illuminates the exterior of the back end of the trailer and the surrounding area. The light from a lamp 216 associated with the interior surface of the trailer door 208 illuminates the interior cargo area of the long haul cargo trailer 200.

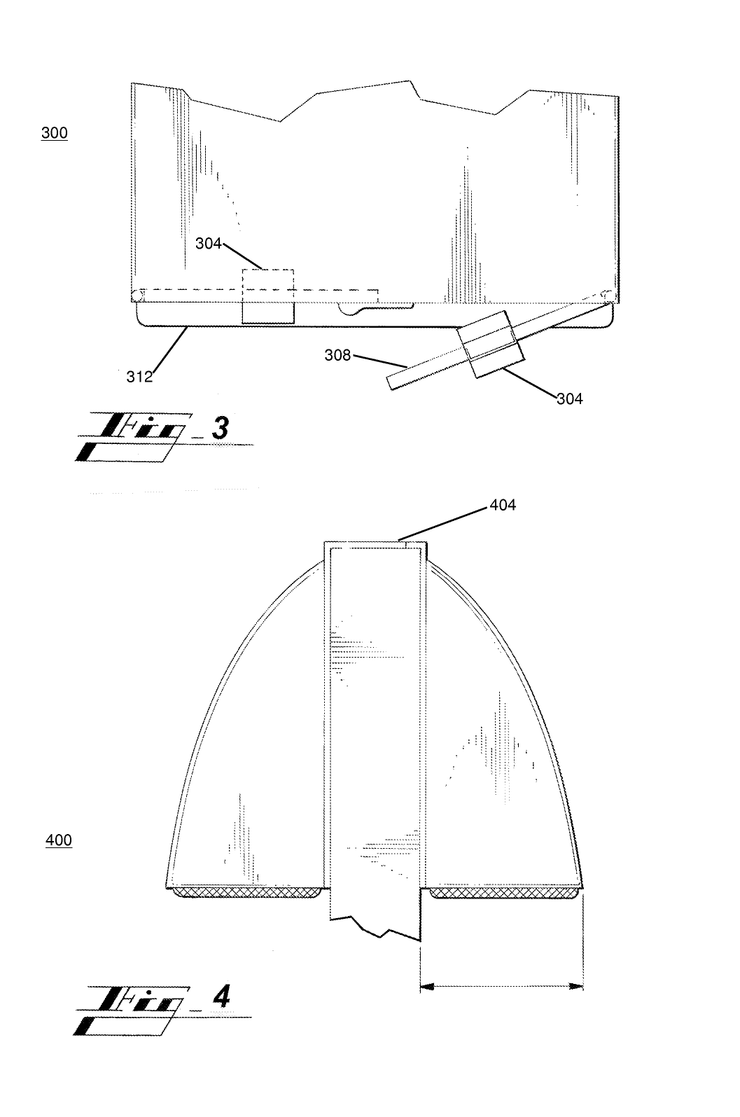

Turning now to FIG. 3, consistent with certain embodiments of the invention this figure is a top view of the remote controlled lights installed on the back doors of a trailer consistent with certain embodiments of the present invention. In this exemplary embodiment, the end of a cargo trailer 300 is shown with two bracket and light assemblies installed. As shown in this non-limiting example, a bracket and light assembly 304 may be installed at the top edge of an open door 308 to provide illumination to the area under the light elements, both inside and outside the cargo trailer when the door 308 to which the bracket and light assembly 304 is attached is open. Additionally, a bracket and light assembly 304 may be installed on the edge of a door that is completely closed 316 without impairing the operation or installation of the bracket and light assembly.

Turning now to FIG. 4, consistent with certain embodiments of the invention this figure is a view of the bracket and light assembly for the remote controlled lights consistent with certain embodiments of the present invention. In an exemplary embodiment, the bracket and light assembly 400 is installed on the upper edge of a door 402 with the bracket 404 in contact with the top surface of the door 402 and light enclosures 408 installed in a downward orientation and in contact with the vertical surfaces of the bracket 404. The light enclosures 408 are securely attached to the vertical surfaces of the bracket using screws, nails, Velcro™ strips, brackets, or other attachment methods that permit secure, but detachable connection to the vertical surfaces 410 of the bracket.

The light enclosures 408 are of sufficient volume to permit the insertion of a lamp (not shown) into the light enclosure. The lamp may be an LED, Halogen, incandescent, energy-saver, or any other type of lamp having a suitable electrical socket portion for insertion and to establish electrical connectivity to a control circuit 412. The bottom-most portion of the light enclosures 408 comprises a removable lens 414 of an appropriate configuration to diffuse the generated light and amplify the area to be illuminated when the lamp is activated. Such lenses are well known in the art and will not be further described herein.

A control circuit 412 is installed within the upper portion of each light enclosure 408 that is electrically connected to the activation socket of each light enclosure 408. The control circuit 412 is a toggle switch (not shown) that is in data communication with a remote switch that may be in the possession of a driver, or be located within the cab of the tractor. The control circuit 412 may be configured with a receiver/transmitter sufficient to receive signals using radio frequency, Bluetooth, BLE, infrared, or any other equivalent electrical wireless signaling means. Upon receipt of a command signal from the toggle switch, the control circuit 412 is operative to complete the electrical connection from a battery (not shown) to the activation socket and turn on the lamp installed within the light enclosure 408. To turn the light off, the driver activates the toggle switch a second time to interrupt the electrical connection between the battery and the activation socket, removing the source of electricity and turning the lamp off.

In an exemplary embodiment, installing the bracket and light assembly on the door or other edged surface begins with separating the bracket and light assembly into a first portion and a second portion. The first portion is placed against the door or other edged surface such that the horizontal portion of the bracket rests on the narrow dimension of the door or edged surface. In a non-limiting example, the first portion may be placed such that the horizontal surface rests on the top edge of a door associated with a cargo trailer. The vertical surface is then preferably in contact with the vertical surface of the door associated with a cargo trailer. In an alternative non-limiting example, the first portion of the bracket may be placed in contact with the edge of the roof portion of a cargo trailer, where the bracket is turned 90 degrees, the horizontal portion is shifted to vertical, and the vertical portion having the light assembly is shifted to horizontal. This configuration permits the bracket and light assembly to be attached such that the light from the lamp is cast into the body of the cargo trailer.

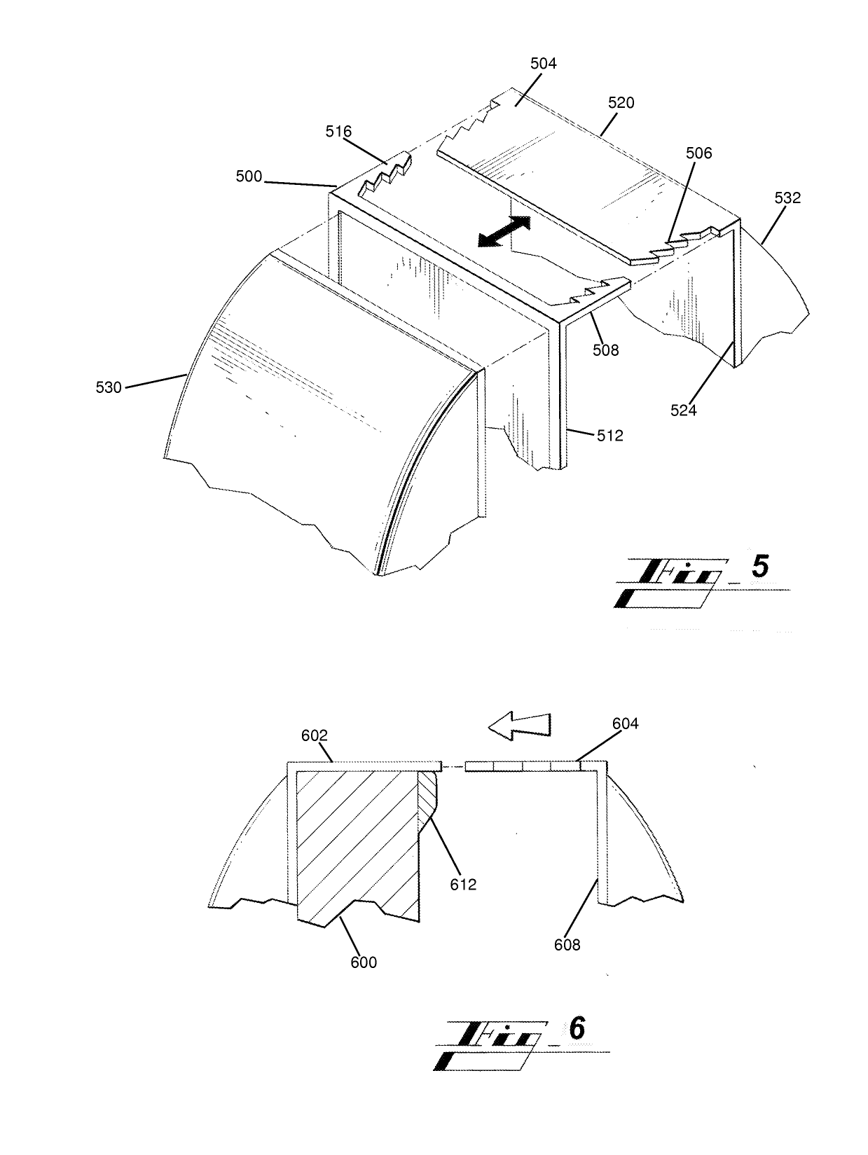

Turning now to FIG. 5, consistent with certain embodiments of the invention is a top view of a bracket closure component of the remote controlled lights consistent with certain embodiments of the present invention. The bracket is composed of two interlocking sections, a first section 500 and a second section 504 that interlock to form a substantial U-shape assembly. The first section 500 of the bracket has a front horizontal bracket section 508 attached at a 90 degree angle to a vertical section 512 to form a substantially upside down L-shaped member. The horizontal bracket portion 508 of the first section 500 has one or more interlocking portions 516. An interlocking portion 516 may have one or more square, triangular, curved, or other shapes that project horizontally from an inner edge surface of the horizontal bracket portion 512. The interlocking portion 516 is disposed to form a catch to lock the first section 500 into position when the first section 500 is placed in contact with the second section 504. In an non-limiting example the interlocking portion 516 may comprise a plurality of triangular shaped “teeth” having a slight reverse orientation sufficient to slide past one or more of a plurality of triangular shaped “teeth” disposed on the outer edge of the horizontal portion 506 of the second section 504, and resist being pulled back against those “teeth”, thus forming a secure attachment.

The second section 504 of the bracket has a horizontal section 520 attached at a 90 degree angle to a vertical section 524 to form a substantially upside down L-shaped member. The horizontal section 520 comprises one or more “teeth” 506 that may be inserted to form the interlock between the first horizontal bracket section 508 and the second horizontal section 520. The second horizontal section 520, in this exemplary embodiment, may have “teeth” 506 disposed along the outer edges of the horizontal section 508 of sufficient shape and size to contact the interlocking portion 516 of the first section 500. Upon moving the horizontal bracket section 508 and interlocking portion 516 in a horizontal direction sufficient to move the horizontal bracket section 508 from initial contact to full insertion into the horizontal bracket portion 508, the “teeth” 506 of the interlocking portion 516 move into the horizontal bracket portion 508 of the first portion 500 and remain in contact. The contact is sufficient to resist the movement of the interlocking portion 516 in the horizontal direction opposite of the direction necessary to insert the first horizontal bracket section 508. In this manner, the first section 500 and the second section 504 of the bracket are placed in locked contact forming a U-shaped bracket.

In this exemplary embodiment, a first light source 530, such as an LED, Halogen, Incandescent, or other light source, is affixed to the front facing portion of the vertical surface 512 of the first section 500. A second light source 532, of the same or of a different type than the first light source 530, is affixed to the vertical surface 524 of the second section 504. In this fashion, the bracket and light assembly is formed and secured to a trailer door or other edge, permitting illumination of a desired area.

Turning now to FIG. 6, consistent with certain embodiments of the invention this figure is a cutaway view of the bracket closure and bracket of the remote controlled lights consistent with certain embodiments of the present invention. In this exemplary embodiment, a cutaway cross-section of a door 600 is presented with the two sections of the bracket and light assembly in contact sufficient to securely attach the bracket and light assembly to the edge of the trailer door 600. In this non-limiting example, the door may be a back door of a long haul cargo trailer, or may be any door in an area that a user wishes to illuminate.

In this embodiment, the horizontal bracket portion 602 of the first section of the bracket 600 is pressed into contact with the horizontal portion 604 of the second section of the bracket 608. A shock absorption element 612 is positioned between one section of the bracket and light assembly and the surface of the door 600 to secure a tight fit for the bracket and to reduce vibration transmitted from the door to the bracket during operation of the tractor-trailer rig. The shock absorption element 612 may be made of rubber, a polymer, plastic, or any other material having an elastic nature to absorb and dampen transmitted vibration from the door.

In the non-limiting example of attaching the bracket to the top edge of the door of a cargo trailer, the second portion of the bracket and light assembly is brought into contact with the first portion of the bracket and light assembly at the top edge of the door of the cargo trailer. The horizontal portion of the bracket first portion is inserted into the horizontal portion of the second portion of the bracket and light assembly. The driver applies force sufficient to move the second portion of the bracket and light assembly to a position where the vertical portion of the second part is in contact with the vertical surface of the cargo trailer door and the shock absorbing material is positioned between the inner surface of the vertical surface of the second portion of the bracket and the vertical surface of the cargo trailer door. At this point the bracket portions may be securely attached through the locking attachment as previously described to form an upside down “U” shape that places the light portion of the bracket and light assembly in a downward orientation.

To activate the lamps within the light portion of the bracket and light assembly, the driver presses a toggle switch to send a data signal as previously described. A control circuit within the light portion of the bracket and light assembly is operable to receive the control signal. Upon receipt, the control circuit establishes an electrical connection between a battery and the socket of the lamp, causing the lamp to activate and provide illumination. When illumination is no longer required by the driver, the driver has simply to press the toggle switch a second time to interrupt the electrical connection between the battery and the lamp socket and turn the lamp off.

While certain illustrative embodiments have been described, it is evident that many alternatives, modifications, permutations and variations will become apparent to those skilled in the art in light of the foregoing description.

1. A device, comprising:
a bracket having a first half and a second half;
each half of the bracket having a light emitting portion physically affixed to the front-facing portion of the vertical section of each half of the bracket;
the first half and the second half of the bracket operable to attach together through locking portions of the first half and second half of the bracket;
the light emitting portions attached in an orientation such that light from the light emitting portions is emitted in a direction away from the locking portions of each half of the bracket;
the bracket and light emitting portions forming a U-shaped assembly when the locking portions of the first half and the second half of the bracket are engaged so as to lock the first half and the second half together into a connected bracket and light assembly.

2. The device of claim 1, further comprising a battery supplying electricity to the light emitting portions of the bracket and light assembly.

3. The device of claim 1, further comprising a left half bracket portion and a right half bracket portion each of which comprises a vertical portion and a horizontal portion connected at a 90 degree angle junction.

4. The device of claim 1, where the locking portion of the first half comprises a plurality of serrations disposed on the inner surface of a cutout in the horizontal portion of the first half.

5. The device of claim 1, where the locking portion of the second half comprises a plurality of serrations disposed on an outer edge surface of the horizontal portion of the second half, and an open forward face for insertion of a first half.

6. The device of claim 1, where the locking portions of the first half and the second half, when in a locking position, form a U-shaped assembly operative to fit on a top edge of a door or doorframe so as to attach the U-shaped assembly to said top edge of door or doorframe.

7. The device of claim 6, where the door or door frame are part of a trailer section of a long haul tractor-trailer truck.

8. The device of claim 1, where the light emitting portion is turned on and off from a remote switch that is not electrically connected to the device.
